(19) United States
(12) Patent Application Publication
(10) Pub. No.: US 2011/0077850 A1
(43) Pub. Date: Mar. 31, 2011

(54) NAVIGATION DEVICE, METHOD AND PROGRAM

(75) Inventor: Koichi USHIDA, Anjo-shi (JP)

(73) Assignee: AISIN AW CO., LTD., Aichi-ken (JP)

(21) Appl. No.: 12/842,083

(22) Filed: Jul. 23, 2010

(30) Foreign Application Priority Data
Sep. 30, 2009 (JP) 2009-226984
Mar. 29, 2010 (JP) 2010-074055

(51) Int. Cl. G01C 21/00; G06F 3/01; G06F 3/048

(52) U.S. Cl. 701/200; 715/702; 715/810

(57) ABSTRACT

A navigation device includes a display unit, an operation detection unit, and an operation control unit. The display unit displays a map, at least a facility and a vicinity thereof on the map, and an icon. The operation detection unit detects a movement of the icon by a user. The operation control unit sets, when the map of the vicinity of the facility is displayed on the display unit, a predetermined area around a position of the facility as a lead-in area. The operation control unit also executes, when the icon is moved, a function of the icon with respect to the position of the facility if a post-movement position of the icon detected by the operation detection unit is within the lead-in area.

### CROSS-REFERENCE TO RELATED APPLICATION(S)

The disclosure of Japanese Patent Application No. 2009-226984 filed on Sep. 30, 2009 and No. 2010-074055 filed on Mar. 29, 2010, including the specification, claims drawings and abstract thereof, is incorporated herein by reference in its entirety.

### BACKGROUND

1. Technical Field

The present disclosure relates to a navigation device, a method and a program that display an icon, such as a mark, together with a map, and more particularly, to a navigation device, a method and a program, in which a specific function is executed by operating the icon on the map.

2. Related Art

In a known navigation device for a vehicle, a host vehicle position is calculated in real time by using various types of sensors in the vehicle and one or more GPS (Global Positioning System) satellite(s). The calculated host vehicle position is displayed on an electronic map. Further, the navigation device has a function to provide guidance on a route to a destination when a user has designated the destination. Navigation devices of this kind are also common as portable terminals for pedestrians.

Japanese Patent Application Publication No. JP-A-2002-323332 describes a navigation device, in which facilities meeting certain conditions designated by the user are displayed on a list, a map centered on a facility selected by the user from the list is displayed, and a destination can be set on the displayed map.

Japanese Patent Application Publication No. JP-A-2002-328028 describes a navigation device, in which a departure point, a destination, a midway point, and the like can be designated in such a manner that a button object associated with specific processing is displayed together with the map, and when the button object and a coordinate on the map are designated on a touch panel, a mark is generated and displayed at a position on the map corresponding to the designated coordinate.

In the technology of Japanese Patent Application Publication No. JP-A-2002-323332, the destination is set on the map after the map of the vicinity of the facility searched by the user is displayed. Therefore, it is possible to set as the destination not only the facility searched by the user but also an arbitrary point in the vicinity of the searched facility. Also, it is preferable to display the map of the vicinity of the selected facility because the vicinity situation can be confirmed before setting the destination.

In the technology of Japanese Patent Application; Publication No. JP-A-2002-328028, a destination icon and the like are displayed, and the destination and the like are set by a drag operation in which the user selects and moves the respective icon (e.g., the destination icon) with a finger on the touch panel. The user can perform the drag operation while looking at the displayed icon(s), which enables an intuitive operation.

### SUMMARY

In one or more embodiments, a navigation device includes a display unit, an operation detection unit, and an operation control unit. The display unit displays a map, at least a facility and a vicinity thereof on the map, and an icon. The operation detection unit detects a movement of the icon by a user. The operation control unit sets, when the map of the vicinity of the facility is displayed on the display unit, a predetermined area around a position of the facility as a lead-in area. The operation control unit also executes, when the icon is moved, a function of the icon with respect to the position of the facility if a post-movement position of the icon detected by the operation detection unit is within the lead-in area.

In one or more embodiments, a navigation device includes a recording unit, a facility search unit, a display unit, an operation detection unit, and an operation control unit. The recording unit records map information and facility information. The facility search unit searches the map and facility information for a desired facility. The display unit displays an icon and a list of facilities returned by the facility search unit. The operation detection unit detects a movement of the icon by a user onto a display item in the list to select the facility corresponding to the display item. The operation control unit executes a function of the icon with respect to a position of the facility selected by the user, upon detection by the operation detection unit that the icon has been moved onto the display item corresponding to the facility.

In one or more embodiments, a navigation method includes the steps of searching for a desired facility; displaying, on a display unit, an icon together with a map of a vicinity of a search facility found in the searching step; and detecting a movement of the icon by a user. When the map of the vicinity of the search facility is displayed on the display unit, a predetermined area around a position of the search facility is set as a lead-in area. When the icon is moved, a function of the icon is executed with respect to the position of the search facility if a post-movement position of the icon detected in the detecting step is within the lead-in area.

In one or more embodiments, a computer-readable medium containing a program for executing the method is also provided.

### BRIEF DESCRIPTION OF THE DRAWINGS

FIG. 1 is a block diagram of a navigation device according to an embodiment of the present invention.

FIG. 2 is a schematic view of a facility selection screen of the navigation device according to the embodiment of the present invention.

FIG. 3 is a schematic view of a map display screen of the navigation device according to the embodiment of the present invention.

FIG. 4 is a schematic view similar to FIG. 3, additionally showing a lead-in area of the navigation device according to the embodiment of the present invention.

FIGS. 5A and 6A are schematic views similar to FIG. 4, illustrating a destination setting method of the navigation device according to the embodiment of the present invention.

FIGS. 5B and 6B schematic views similar to FIG. 4, illustrating the results of the destination setting method of the navigation device according to the embodiment of the present invention.

FIG. 7 is a flowchart of a method of operating the navigation device according to the embodiment of the present invention.

FIG. 8 is a schematic view of a facility selection screen of the navigation device in a destination setting method of the navigation device according to a further embodiment of the present invention.

FIG. 9 is a schematic view similar to FIG. 5B, illustrating the result of the destination setting method of FIG. 8.

FIG. 10 is a schematic view similar to FIG. 8, illustrating a map display method of the navigation device according to the further embodiment of the present invention.

FIG. 11 is a schematic view similar to FIG. 9, illustrating the result of the map display method of FIG. 10.

### DETAILED DESCRIPTION

One or more embodiments of the present invention will be described in further detail below in conjunction with the accompanying drawings. In the description, the same symbols and signs in the drawings refer to the same or corresponding elements or function parts; therefore, overlapped explanation will be omitted.

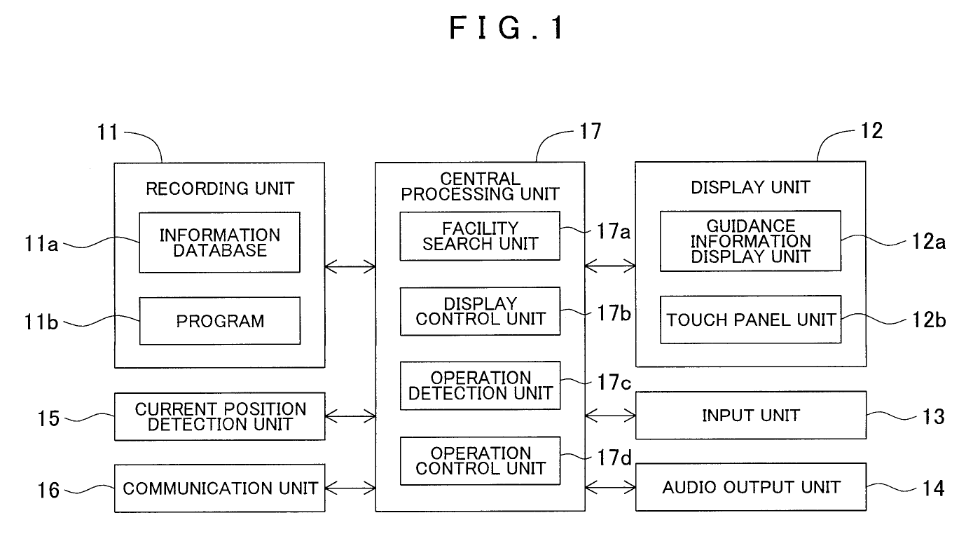

FIG. 1 is a block diagram of a navigation device according to an embodiment. The navigation device is for use in a vehicle, such as an automobile, or is a portable device arranged for use by a pedestrian or hiker or rider etc. Such a navigation device in some embodiments include any vehicle-built-in or after-market devices as well as mobile or portable devices, such as cellular telephones, personal digital assistants, laptop or tablet computers etc.

The navigation device includes a hardware computer platform, that can execute software applications and display guidance data. The navigation device is considered to include multiple units each for performing one or more specific functions. The functions are embodied in hardware either via hardwiring or via software execution on such hardware. Software comprising instructions for execution resides in a computer-readable medium (i.e., readable and executable by a computer platform) as will be described herein below in detail.

In the specific embodiment disclosed in FIG. 1, the navigation device is provided with a recording unit 11, an display unit 12, an input unit 13, an audio output unit 14, a current position detection unit 15, a communication unit 16, and a central processing unit 17.

The recording unit 11, is a computer-readable recording medium that records programs and/or information necessary for a navigation function. The recording unit 11 in some embodiments includes external/removable and/or internal/built-in storage or memory unit, e.g., one or more of an optical disk, such as a DVD, a magnetic disk, such as a hard disk, a semiconductor memory, such as a memory card, and the like.

The recording unit 11 records data such as an information database 11a to record information, a program 11b to execute various functions of the navigation device, and the like. The information database 11a records road data representing a connection relation of roads, facility data representing a name and a position of a facility, guidance data necessary for route guidance, map data used in various types of functions for navigation, and the like. The program 11b records an operation program that performs an operation according to a manipulation of the user, a search program that performs search for the facility, a display control program that controls information to display, and the like. The information database 11a and the program 11b may be recorded in different recording media. For example, the program 11b may be included in the recording unit 11 of the navigation device, and the information database 11a may be recorded in the recording unit 11 of an external server and the information may be acquired through communication via the communication unit 16.

The display unit 12, which is a display device that outputs image information for the navigation, includes a liquid crystal display provided in the navigation device or the vehicle, and the like. The display unit 12 mainly operates as a guidance information display unit 12a that displays various kinds of guidance information. However, if the display unit 12 has a function as an input device, the display unit 12 is provided with a touch panel unit 12b that detects a touch of a finger of the user. The guidance information display unit 12a displays information necessary for various kinds of operation and guidance of the navigation device such as map information, facility information, an icon, a menu, and the like. The touch panel unit 12b detects a touch position of the finger of the user when the display unit 12 operates as the input device.

The input unit 13, which is the input device that operates the navigation device, includes a button, a mouse, a microphone for performing an audio input by the user, and the like. In addition, the touch panel unit 12b of the display unit 12 operates as the input unit 13. These members instruct various kinds of processing to the central processing unit 17 upon an input operation of the user, such as setting the destination and performing a scroll operation of a map.

The audio output unit 14, which is an audio output device that outputs audio information for navigation, includes a speaker provided in the navigation device or the vehicle, and the like. The audio output unit 14 provides the user with the navigation function, for example, by outputting route guidance such as a right/left turn at an intersection by audio.

The current position detection unit 15, which corresponds to various kinds of antennas and sensors that detect a current position of the vehicle and the navigation device, includes a GPS receiver, a beacon receiver, an absolute direction sensor, a relative direction sensor, a distance sensor, and the like. An electronic device such as a personal computer having a function to set the destination on the map and output the guidance information of a route and the like is also a kind of the navigation device. However, such device may not include the current position detection unit 15.

The communication unit 16, which corresponds to various kinds of antennas, communication devices, and the like that transmit and receive information stored in the navigation device and the vehicle, receives road information transmitted from a broadcasting station and a beacon, and acquires information necessary for the user by performing communication with external centers.

The central processing unit (CPU) 17 includes a an application-specific integrated circuit (“ASIC”), a chipset, a processor, a microprocessor, a logic circuit, or other data processing device that executes various kinds of computing processing according to the program in a RAM (e.g., the recording unit 11 or part thereof) that is used as a working memory when the CPU executes the various kinds of computing processing, and the like. The central processing unit 17 performs overall control of the navigation device.

In the present embodiment, the central processing unit 17 includes: a facility search unit 17a that searches for the facility from the information database 11a based on the conditions inputted by the user with the input unit 13; a display control unit 17b that displays the map of a vicinity of a search facility including the facility searched by the user; an operation detection unit 17c that detects a movement of an icon when the user operates the icon displayed on the guidance information display unit 12a; an operation control unit 17d that executes a function determined based on the movement of the icon as detected by the operation detection unit 17c.

When the user performs a movement operation on the icon displayed on the guidance information display unit 12a, the button, the mouse, or the touch panel unit 12b as the input unit 13 is used. In case of using the button, the icon is moved for example by moving a displayed cursor to over the icon with a cross key, selecting the icon by pressing the button, moving the icon with the cross key, and canceling the selection. A merit of an operation with the button is that the operation can be performed at a position far from the navigation device with use of a remote controller or the like. In case of using the mouse, the displayed icon is moved for example by a drag operation. A merit of an operation with the mouse is that the operation is easier than the operation with the button. In case of using the touch panel, the icon is moved for example by touching the displayed icon with a finger and performing the drag operation. A merit of an operation with the touch panel is that the operation can be intuitively performed.

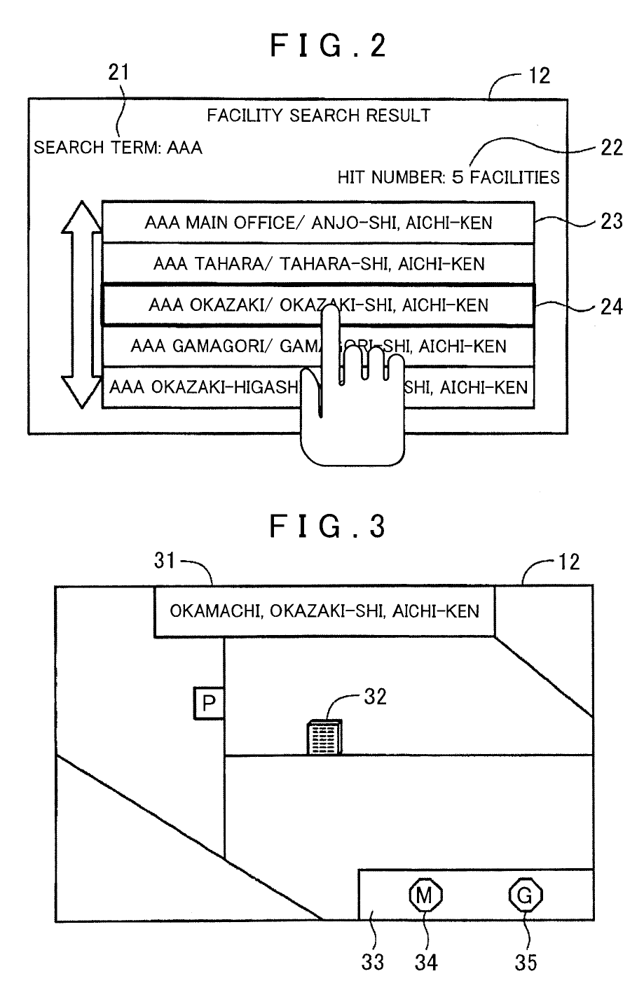

FIG. 2 shows an example of a facility selection screen of the navigation device according to the embodiment of the present invention. Hereinafter, an exemplary case in which the user sets a facility “AAA Okazaki” as the destination is described with reference to the drawings. Search functions such as an address search, a category search, a telephone number search, and the like are included as search methods of the facility. In the present embodiment, a name search by a facility name is performed. When the user inputs “AAA” as a search term, facility search processing is executed by the facility search unit 17a and a facility search result is displayed on the display unit 12. Specifically, a facility list 23 including “AAA” in names is displayed as the facility search result. In addition, information such as “AAA” that was inputted as the search term, a hit number “5 facilities” as a result of the facility search, and the like is also displayed in a search term display area 21 and a hit number display area 22, respectively.

When the user selects from the facility list 23 a search result display item 24 where “AAA Okazaki” as the destination is displayed, the map centered on the “AAA Okazaki” as the search facility is called by the display control unit 17b and displayed on the display unit 12. In the present embodiment, the touch panel to directly touch the display unit 12 is utilized when selecting a facility from the facility list 23. However, another input unit 13 such as the button, the remote control, or the like may be utilized in the same manner.

FIG. 3 shows a screen example that the map centered on “AAA Okazaki” 32 as the search facility is displayed on the display unit 12. The “AAA Okazaki” 32 is displayed at the center of the screen of the display unit 12. In addition, an address of the vicinity of the map displayed on the screen is displayed in an address display area 31, and icons such as a memory point icon 34, a destination icon 35, and the like are displayed in a function icon area 33.

A function is assigned to each of the icons displayed in the function icon area 33. When the user selects one of the icons and moves on the screen, the assigned function is executed with respect to the position after the movement. For example, the function to register the position after the movement as a memory point is assigned to the memory point icon 34, and the position registered as the memory point will be easily recalled later in the map or the like. In addition, the function to set the position after the movement as the destination is assigned to a destination icon 35, and the route to the position set as the destination is searched by the central processing unit 17.

In case of setting the “AAA Okazaki” 32 as the destination using the destination icon 35, the user moves the destination icon 35 to the position of the “AAA Okazaki” 32. In this operation, it might be difficult to accurately move the destination icon 35 to the position of the “AAA Okazaki” 32. If the position of the destination icon 32 at the end of the movement is off the position of the “AAA Okazaki” 32, the destination is set to a position that is different from the position of the “AAA Okazaki” 32. In some cases, a route to a road that is not adjacent to the “AAA Okazaki” 32 is searched. In order to prevent such inconvenience, in the present embodiment of the present invention, a lead-in area is set in the vicinity of the search facility.

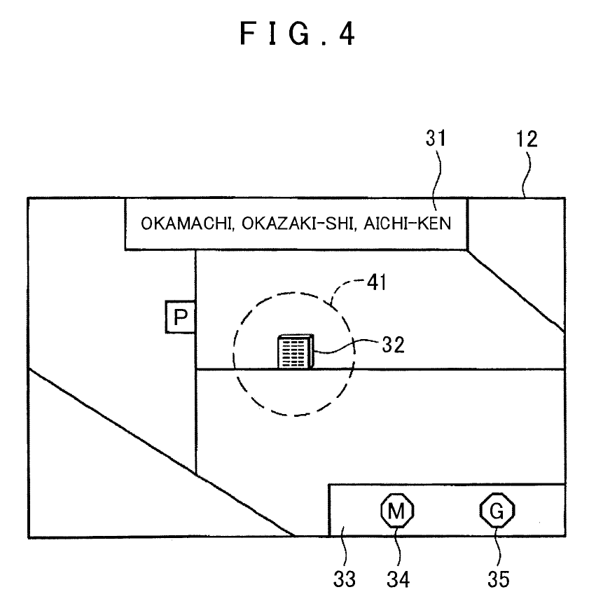

FIG. 4 shows an example of the lead-in area in accordance with the present embodiment, i.e., a lead-in area 41 is set in the vicinity of the “AAA Okazaki” 32 as the search facility. The lead-in area 41 is set for example to a circle with a 100-meter radius centered on the “AAA Okazaki” 32. Other arrangements, such as lead-in areas of different sizes and/or shapes are within the scope of this disclosure. In one or more embodiments, if multiple search facilities from the facility list 23 are displayed on the map, several or all the displayed search facilities are provided with respective lead-in areas. In one or more embodiments, facilities that are not in the facility list 23 but are displayed on the map (e.g., the parking lot P in FIG. 4) are also provided with respective lead-in areas.

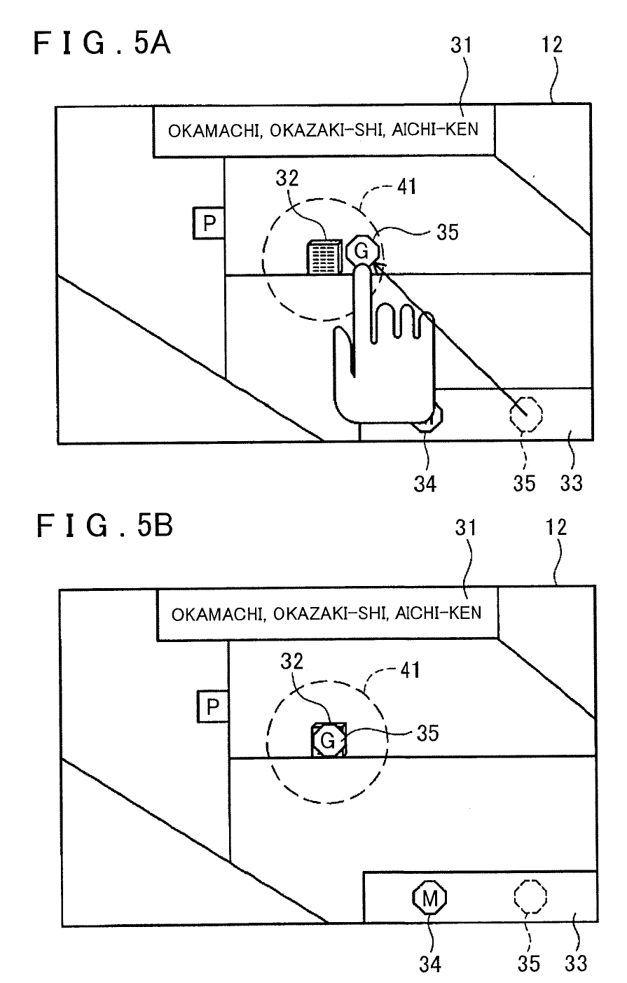

FIGS. 5A and 5B show an operation in case of moving the destination icon 35 to within the lead-in area. When the user has moved the destination icon 35, if the position after the movement is inside the lead-in area 41 as shown in FIG. 5A, the operation control unit 17d judges that the destination icon 35 was moved to the position of the “AAA Okazaki” 32 and the destination icon 35 is set to the position of the “AAA Okazaki” 32 as shown in FIG. 5B. In this manner, it is only necessary to move the destination icon 35 to the vicinity of the “AAA Okazaki” 32 if it is desired to set the destination to the “AAA Okazaki” 32; therefore, the operation becomes easy for the user.

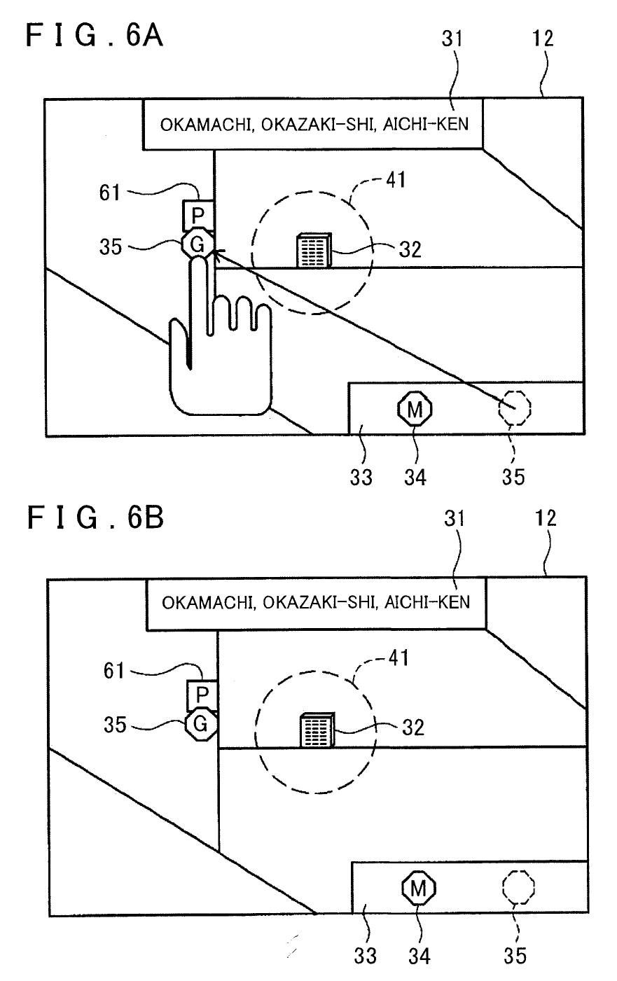

FIGS. 6A and 6B show an operation in case of moving the destination icon 35 to outside the lead-in area. When the user has moved the destination icon 35, if the position after the movement is outside the lead-in area 41 as shown in FIG. 6A, the destination icon 35 is directly set to the moved position as shown in FIG. 6B. In case of FIGS. 6A and 6B, the destination icon 35 is moved to a position of a parking lot 61; therefore, the position of the parking lot 61 is set as the destination. As discussed above, the parking lot 61, although not present in the facility list 23, is still provided with a lead-in area in some embodiments to facilitate the user's operation.

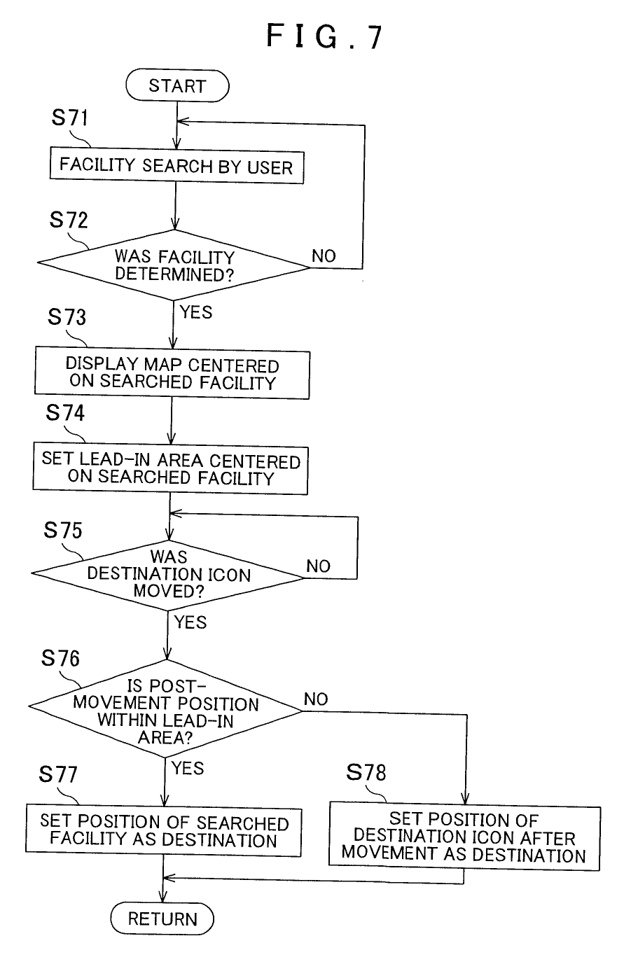

FIG. 7 is a flowchart of an operating method of the navigation device according to the present embodiment. The operating method is performed during the execution of a main program of the navigation device. When the user inputs search conditions and performs facility search, the facility search unit 17a performs the search (Step S71) and the search result is displayed on the facility list 23 as shown in FIG. 2.

When the user selects a facility (e.g., “AAA Okazaki” 32) as the destination from the facility list 23 (Step S72: YES), the map centered on the selected search facility is displayed (Step S73) and the lead-in area centered on the search facility is set (Step S74). If the user does not select a facility from the facility list 23 but gives an instruction to go back because the facility desired for the destination is not listed or there are too many facilities to be displayed on the list, the procedure returns to a search menu (Step S72: NO).

When the user selects and moves the destination icon from the function icon area 33 (Step S75: YES) onto the map display area, the operation detection unit 17c detects the moved position of the destination icon and the operation control unit 17d judges whether or not the moved position of the destination icon is within the lead-in area (Step S76). If the moved position of the destination icon is within the lead-in area, the operation control unit 17d sets the selected facility as the destination (Step S77). If the moved position of the destination icon is outside the lead-in area, the destination is directly set to the moved position (Step S78).

Next, another embodiment of the facility selection screen in FIG. 2 will be described.

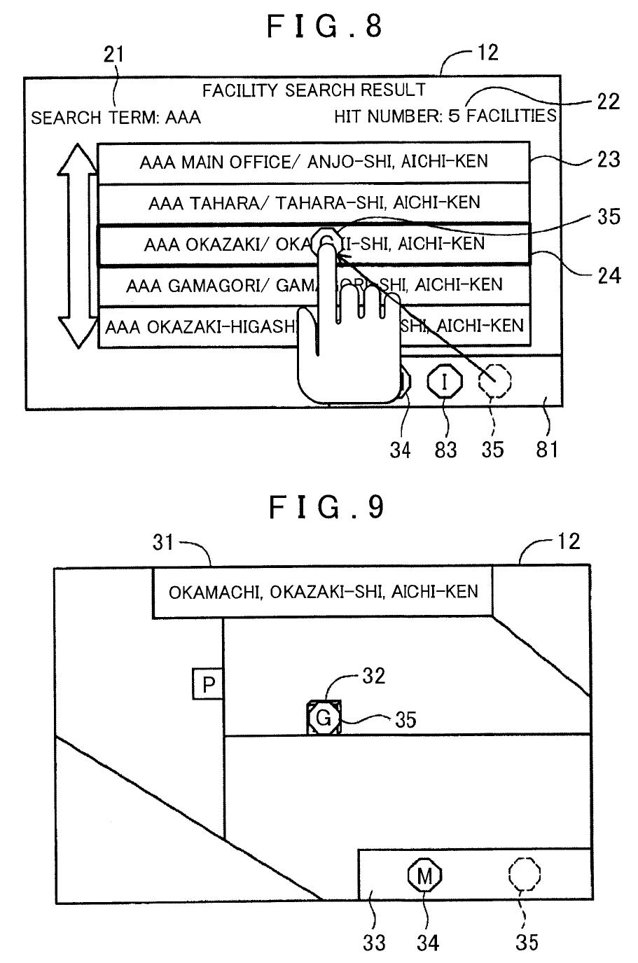

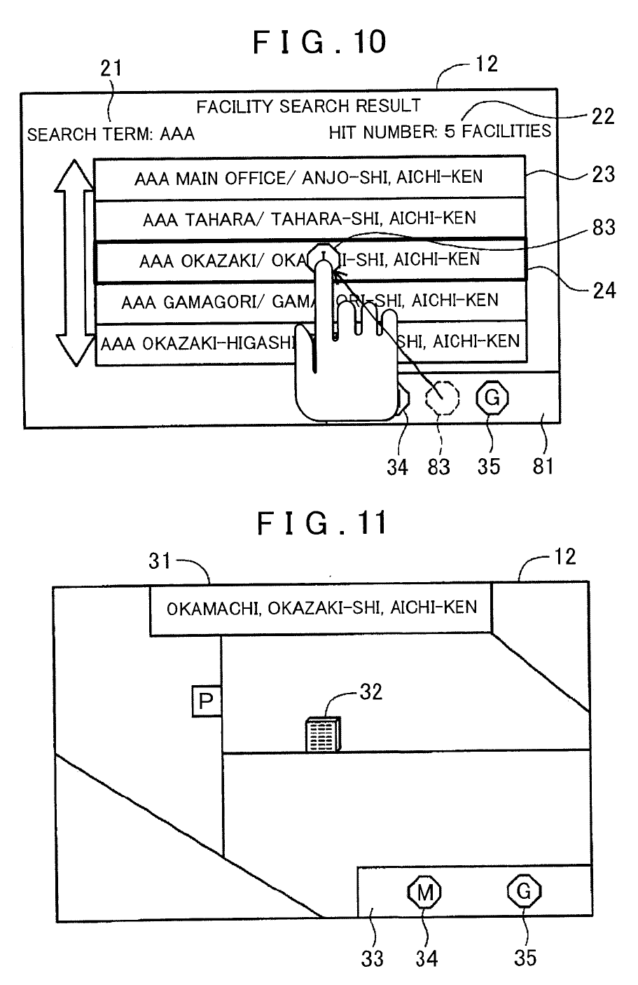

For example, when the user inputs “AAA” as the search term, the facility search processing is executed by the facility search unit 17a and the facility search result is displayed on the display unit 12, as shown in FIGS. 8 and 10. Specifically, the facility list 23 including “AAA” in names is displayed as the facility search result. In addition, the information such as “AAA” that was inputted as the search term, the hit number “5 facilities” as a result of the facility search, and the like is also displayed in the search term display area 21 and the hit number display area 22 respectively.

Here, a function icon area 81 is displayed at the lower-right part of the display unit 12. In the function icon area 81, the memory point icon 34, the destination icon 35, and a map display icon 83 are displayed. The memory point icon 34 includes a function to register as the memory point the position on the map of the search facility that corresponds to a facility name (the facility information) displayed at the position in the facility list 23 where the memory point icon 34 was moved, and the position registered as the memory point will be easily recalled later in the map or the like.

The destination icon 35 includes a function to set as the destination the position on the map of the facility that corresponds to the facility name (the facility information) displayed at the position in the facility list 23 where the destination icon 35 was moved, and the route to the position set as the destination will be searched by the central processing unit 17.

For example, as shown in FIGS. 8 and 9, if the destination icon 35 is moved onto the “AAA Okazaki/Okazaki-shi, Aichi-ken” displayed in the search result display area 24 in the facility list 23, the search facility “AAA Okazaki” 32 corresponding to the “AAA Okazaki/Okazaki-shi, Aichi-ken” is set as the destination. And, the map centered on the search facility “AAA Okazaki” 32 as the destination is displayed on the display unit 12, and also the destination icon 35 is accurately displayed at the position of the “AAA Okazaki” 32. Then, a route to the “AAA Okazaki” 32 is searched.

In addition, an address of the vicinity of the map displayed on the screen is displayed in the address display area 31, and the memory point icon 34 is displayed in the function icon column 33. That is, if the destination icon 35 is moved to the desired facility “AAA Okazaki/Okazaki-shi, Aichi-ken” in the facility list 23, the destination icon 35 is moved to the position of the desired facility “AAA Okazaki” 32 on the map.

If information of the vicinity of the “AAA Okazaki” 32 is required, when moving the map display icon 83 onto the facility list 23, the map centered on the “AAA Okazaki” 32 is displayed, as shown in FIG. 3. The map display icon 83 includes a function to display on the display unit 12 the map of the vicinity of the search facility that corresponds to the facility name (the facility information) displayed at the position in the facility list 23 where the map display icon 83 was moved.

For example, as shown in FIGS. 10 and 11, if the map display icon 83 is moved onto the “AAA Okazaki/Okazaki-shi, Aichi-ken” displayed in the search result display area 24 in the facility list 23, the map centered on the search facility “AAA Okazaki” 32 that corresponds to the “AAA Okazaki/Okazaki-shi, Aichi-ken” is displayed on the display unit 12. In addition, an address of the vicinity of the map displayed on the screen is displayed in the address display area 31, and icons such as the memory point icon 34 and the destination icon 35 are displayed in the function icon area 33. That is, the same state as the aforementioned FIG. 3 is given. The subsequent operations are also the same; therefore, the description is omitted.

Thus, by moving the destination icon 35 displayed in the function icon area 81 onto the desired facility name in the facility list 23, the user can easily display on the display unit 12 and confirm the map of the vicinity centered on the search facility that corresponds to the facility name displayed in the corresponding search result display area 24. At the same time, the destination icon 35 is accurately displayed at the position on the map of the search facility, and a right route to the search facility is searched.

In addition, by moving the map display icon 83 displayed in the function icon area 81 onto the desired facility name in the facility list 23, the user can easily display on the display unit 12 and confirm the map of the vicinity centered on the search facility that corresponds to the facility name displayed in the corresponding search result display area 24. Further, icons such as the memory point icon 34 and the destination icon 35 are displayed on the display unit 12, and destination or the like can be quickly set by operating the destination icon 35 or the like.

Thus, one or more embodiments of the present invention provide a navigation device, a method and a program, in which a position setting can be accurately performed when operating the icon on the map.

In one or more embodiments according to a first aspect, respective functions are assigned to the respective icons displayed on a map screen, and when the user moves one of the icons, the function of the icon is executed with the position after the movement. Specifically, when the user moves an icon, an operation detection unit detects a movement of the icon and a post-movement position of the icon. The respective functions such as destination setting, memory point setting, or the like are set to the respective icons.

When a facility (e.g., a search facility) is displayed on the map, an operation control unit sets a lead-in in the vicinity of the facility. If the post-movement position of the icon detected by the operation detection unit is within the lead-in area, the operation control unit executes the function of the icon with respect to the position of the facility, judging that the icon was moved to the position of the facility. If the detected post-movement position of the icon is not within the lead-in area, the operation control unit executes the function of the icon with respect to the post-movement position of the icon.

Consequently, when the user moves the icon to the position of the facility, it is not necessary to move the icon to the exact position of the facility, but it is only necessary to move the icon to the vicinity of the facility; therefore, the operation for selecting the facility becomes easy. In addition, the lead-in area is limited to the vicinity of the facility; therefore, the user can perform movement in a usual manner if the user desires to move the icon to a position other than the facility.

In one or more embodiments according to a second aspect, the destination for the navigation is set when the user moves a destination icon. The destination icon is to set the post-movement position, where the icon was moved, as the destination for the navigation. If the post-movement position of the destination icon is within the lead-in area, the operation control unit sets the position of the facility as the destination, judging that the destination icon was moved to the position of the facility. Therefore, the operation is as easy as the first aspect.

In one or more embodiments according to a third aspect, a touch panel unit is provided to perform an input by a finger's touch. The operation detection unit detects a drag operation by the user based on the input from the touch panel unit. If the post-movement position of the icon subjected to the drag operation is within the lead-in area, the operation control unit executes the function of the icon with respect to the position of the facility, judging that the icon was moved to the position of the facility.

Thus, the icon is moved by the drag operation of a finger on the touch panel. Therefore, intuitive icon operation becomes possible in addition to the effects of the first and/or second aspect(s).

In one or more embodiments according to a fourth aspect, a program and a method are also provided to perform the functions described with respect to the first aspect, thereby, achieving at least the same effects as the first aspect.

In one or more embodiments according to a fifth aspect, an icon is moved to a display item (e.g., a search result display item) in a list of display items. Each display item corresponds to a facility. The function associated with the icon is executed with respect to the position of the facility corresponding to the display item to which the icon was moved. Thus, it is not necessary to move the icon to the exact position of the facility on the map, but it is only necessary to move the icon to a display item corresponding to the facility; therefore, the operation for selecting the facility becomes easy.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A navigation device, comprising:
a display unit for displaying a map, at least a facility and a vicinity thereof on the map, and an icon;
an operation detection unit for detecting a movement of the icon by a user; and
an operation control unit for
when the map of the vicinity of the facility is displayed on the display unit, setting a predetermined area around a position of the facility as a lead-in area, and
when the icon is moved, executing a function of the icon with respect to the position of the facility if a post-movement position of the icon detected by the operation detection unit is within the lead-in area.

2. The navigation device according to claim 1, wherein
the operation control unit is configured for, when the icon is moved, executing the function of the icon with respect to the post-movement position of the icon if the post-movement position of the icon detected by the operation detection unit is outside the lead-in area.

3. The navigation device according to claim 1, wherein
the icon is a destination icon to set the post-movement position of the icon as a destination, and
the operation control unit is configured for setting the position of the facility as the destination if the post-movement position of the destination icon is within the lead-in area.

4. The navigation device according to claim 1, wherein:
the display unit has a touch panel unit;
the operation detection unit is configured for detecting a drag operation by the user based on an input from the touch panel unit; and
the operation control unit is configured for executing the function of the icon with respect to the position of the facility if the icon was subjected to the drag operation and moved to within the lead-in area.

5. The navigation device according to claim 1, further comprising:
a recording unit for recording map information and facility information; and
a facility search unit for searching the map and facility information for a desired facility based on the user's input;
wherein the display unit is configured for
displaying a list of facilities returned by the facility search unit; and
upon user's selection of the facility from said list, displaying the facility and the vicinity thereof on the map.

6. The navigation device according to claim 5, wherein:
the display unit is configured for displaying a further icon together with the list of facilities returned by the facility search unit;
the operation detection unit is configured for detecting a movement of the further icon onto a display item in said list, said display item corresponding to the facility selected by the user; and
the operation control unit is configured for executing a function of the further icon with respect to the position of the facility selected by the user upon detection by the operation detection unit that the further icon has been moved onto the display item corresponding to said facility.

7. The navigation device according to claim 6, wherein:
the further icon is a destination icon to set the post-movement position of the icon as a destination, and
the operation control unit is configured for, upon detection by the operation detection unit that the destination icon has been moved onto the display item corresponding to said facility,
causing the display unit to display the facility and the vicinity thereof on the map, and
setting the position of the facility as the destination.

8. The navigation device according to claim 6, wherein:
the further icon is a map display icon, and
the operation control unit is configured for, upon detection by the operation detection unit that the map display icon has been moved onto the display item corresponding to said facility, causing the display unit to display the facility and the vicinity thereof on the map.

9. A navigation device, comprising:
a recording unit for recording map information and facility information; and
a facility search unit for searching the map and facility information for a desired facility;
a display unit for displaying an icon and a list of facilities returned by the facility search unit;
an operation detection unit for detecting a movement of the icon by a user onto a display item in said list to select the facility corresponding to said display item; and
an operation control unit for executing a function of the icon with respect to a position of the facility selected by the user, upon detection by the operation detection unit that the icon has been moved onto the display item corresponding to said facility.

10. The navigation device according to claim 9, wherein
the icon is a destination icon to set a post-movement position of the icon as a destination, and
the operation control unit is configured for, upon detection by the operation detection unit that the destination icon has been moved onto the display item corresponding to said facility,
causing the display unit to display the facility and a vicinity thereof on the map, and
setting the position of the facility as the destination.

11. The navigation device according to claim 9, wherein:
the icon is a map display icon, and
the operation control unit is configured for, upon detection by the operation detection unit that the map display icon has been moved onto the display item corresponding to said facility, causing the display unit to display the facility and a vicinity thereof on the map.

12. The navigation device according to claim 11, wherein:
the operation control unit is configured for
causing the display unit to display, together with the map of the facility and the vicinity thereof, a further icon;
setting a predetermined area around the position of the facility as a lead-in area; and
upon detection by the operation detection unit that said further icon has been moved into the lead-in area, executing a function of said further icon with respect to the position of the facility.

13. The navigation device according to claim 12, wherein:
the operation control unit is configured for, when the further icon is moved, executing the function of the further icon with respect to a post-movement position of the further icon if the post-movement position of the further icon detected by the operation detection unit is outside the lead-in area.

14. A navigation method, comprising the steps of.
searching for a desired facility;
displaying, on a display unit, an icon together with a map of a vicinity of a search facility found in the searching step;
detecting a movement of the icon by a user; and
when the map of the vicinity of the search facility is displayed on the display unit, setting a predetermined area around a position of the search facility as a lead-in area, and
when the icon is moved, executing a function of the icon with respect to the position of the search facility if a post-movement position of the icon detected in the detecting step is within the lead-in area.

15. The navigation method according to claim 14, further comprising
when the icon is moved, executing the function of the icon with respect to the post-movement position of the icon if the post-movement position of the icon detected in the detecting step is outside the lead-in area.

16. The navigation method according to claim 14, further comprising
displaying, on the display unit, a list of facilities returned by the searching step; and
upon user's selection of the facility from said list, displaying the facility and the vicinity thereof on the map.

17. The navigation method according to claim 16, further comprising
displaying a further icon together with the list of facilities returned by the searching step;
detecting a movement of the further icon onto a display item in said list, said display item corresponding to the facility selected by the user; and
executing a function of the further icon with respect to the position of the facility selected by the user upon detection that the further icon has been moved onto the display item corresponding to said facility.

18. A computer-readable medium containing a program for causing, when executed by a computer, which comprises a recording unit that records map information and facility information and a display unit, the computer to execute the method of claim 14.
